(19) United States
(12) Patent Application Publication
(10) Pub. No.: US 2016/0354973 A1
(43) Pub. Date: Dec. 8, 2016

(54) PLASTIC-WELDING DEVICE

(71) Applicant: Ralph MEICHTRY, Feusisberg (CH)

(72) Inventors: Meichtry Ralph, Feusisberg (CH); Beat BASLER, Horgen (CN)

(73) Assignee: Ralph MEICHTRY, Feusisberg (CH)

(21) Appl. No.: 15/103,787

(22) PCT Filed: Dec. 5, 2014
(86) PCT No.: PCT/EP2014/076773

§ 371 Date: Aug. 8, 2016

Related U.S. Application Data
(63) Continuation of application No. 13/010,944, filed on Jan. 21, 2011, now Pat. No. 8,324,484.

(30) Foreign Application Priority Data
Dec. 10, 2013 (DE) 20 2013 010 944.0

(51) Int. Cl. B29C 65/00; B29C 65/60; B29C 65/78; B29C 65/42

(52) U.S. Cl. CPC B29C 66/8616; B29C 65/42; B29C 65/60; B29C 65/7811; B29C 66/0342; B29C 66/21; B29C 66/43; B29C 66/8322; B29C 66/861; B29C 66/86531; B29L 2031/3044

(57) ABSTRACT

The invention relates to a plastic-welding device for connecting a first, thin-walled plastic part (6) to a second plastic part in a planar manner, comprising a hand-held mounting aid (1) and a welding head (2) that can be held in a retainer of a hand soldering iron; wherein the welding head (2) has a main body (3) and at least one welding tip (4) arranged on the main body (3); wherein the mounting aid (1) has at least one spacer (5), which can be placed onto the thin-walled plastic part (6) by means of an underside of the at least one spacer and on the surface of which the main body (3) of the welding head (2) can be supported; and wherein the at least one spacer (5) is designed in such a way that, when the main body (3) is supported on the at least one spacer (5), a depth of penetration of the at least one welding tip (4) into the plastic parts to be connected is limited to a predetermined maximum value.

### BACKGROUND OF THE INVENTION

Field of the Invention

The invention relates to a handheld plastic welding device.

Discussion of Related Art

In motor vehicles that include parking sensors or distance sensors, respectively, the sensors are often disposed behind the plastic covering of the bumpers. Sensor retainers composed of plastic are welded to the inside of the plastic covering by an industrial ultrasonic welding process. Whenever the plastic covering or the bumper has to be replaced, the replacement parts are generally supplied without sensor retainers, and thus the sensor retainers must be installed in an automotive workshop. Automotive workshops, however, typically do not have the expensive ultrasound welding equipment, with the result that the sensor retainers are simply glued in place. The problem here is that glued-on sensor retainers do not hold with sufficient strength and soon fall off again after a short period of time.

### SUMMARY OF THE INVENTION

An object of the invention is to provide a handheld plastic welding device for the planar joining of a first thin-walled plastic part to a second plastic part, which is cost efficient to produce and easy to use.

In one embodiment, the plastic welding device for the planar joining of a first thin-walled plastic part to a second plastic part comprises a handheld installation aid and a welding head that is preferably designed so that it can be received in a retainer of a hand soldering iron. The welding head includes a base body and at least one welding tip disposed on the base body. The handheld installation aid includes at least one spacer. In order to weld, the installation aid can be placed on the thin-walled plastic part by the bottom side of the at least one spacer. The base body of the welding head is supported on the top side of the at least one spacer in order to join the two plastic parts. In addition, the at least one spacer is designed so as to limit to a predetermined maximum value of a penetration depth of the at least one welding tip into the plastic parts to be joined when the base body is supported laterally on the at least one spacer. The maximum value of the penetration depth is preferably in the range from approximately 2 to 6 mm.

In order to join the two plastic parts, the first thin-walled plastic part is positioned at the desired spot on the second plastic part, then pressed into place or held in place by the handheld installation aid that preferably includes a handle. The bottom side of the at least one spacer thus functions to hold in place the first plastic part on the second plastic part. Alternatively, the first plastic part can also be held in place by the retaining element disposed next to the spacer, e.g., by means of a central attachment body that is explained below. The welding head is then pressed into the second plastic part by the at least one welding tip through the thin-walled section of the first plastic part until the welding head rests with the base body on the spacer. Hereby, the at least one spacer is designed to allow only a predetermined maximum penetration depth of the welding tip, which depth is dependent on the thickness of the thin-walled plastic part. As the welding tip is pressed in, the two plastic parts are melted in the region of the welding tip and joined together. When the welding head is extracted, the plastic continues to remain soft in the joined region, and the fact that the first plastic part continues to be held by the installation aid prevents this part from detaching together with the welding head.

A further advantage of the at least one spacer is the fact that the base body of the welding head, which is preferably plate-shaped, does not contact the first plastic part and this prevents an extended area from melting. The distance between the base body of the welding head and the plastic part preferably measures at least 0.5 mm.

The spacer can be plate-shaped and can include a cutout, e.g., in the form of a circle or rectangle, for the welding head, which cutout is sized so that the base body of the welding head during welding rests only on one edge region on the spacer. The at least one welding tip projects through the cutout. Alternatively, the installation aid can also include two spacers separated a certain distance apart, between and through which the welding tip can project. These can be attached to a central attachment body, e.g., in the form of a brace or an attachment plate. For example, the spacers can be in the form of angle brackets that are attached by one leg to the central attachment body. Alternative forms are also possible. The brace or the attachment plate can include, for example, two protruding separated elements that each include a flange on their sides facing each other, each flange forming the spacer. These protruding elements can also function simultaneously as a guide for the base body of the welding head. The welding head can also include a flange that is complementary to the flange of the spacer, thereby enhancing the stability of the welding head relative to the installation aid.

The installation aid of the plastic welding device can include a guide for the welding head. The guide, for example, can be in the form of protruding elements and/or the attachment plate.

The installation aid preferably includes a handle. The handheld installation aid can thus essentially include at least one spacer that is disposed on a handle. In particular, when there are two spacers disposed a certain distance apart, these are preferably fastened to the handle through a central attachment body. The shape of the installation aid here can resemble approximately the fork of a forklift.

In order to allow the installation aid to be adjusted for different penetration depths, the spacers can be removably attached to the central attachment body, resp. the brace or the attachment plate, thereby making it possible to easily replace spacers of varying thicknesses (e.g., in the case of angle brackets) resp. those having a flange of varying thickness. Alternatively, additional small spacer plates can be attached to the bottom side of the spacers in order to shorten the penetration depth.

The welding head, preferably one fabricated out of steel or copper, can have a base body comprising a plurality of welding tips, e.g., 4, 6, 8, or 12 tips. These can be arranged, for example, uniformly in one or more rows. Other arrangements, e.g., in a radial or circular fashion, are also possible depending on the application. The shape of the welding tips can be cylindrical, rectangular, pyramidal, or trapezoidal. They can be 4 to 8 mm long and 1-3 mm in cross-section.

Optionally, a cooling die that is also part of the plastic welding device can be used after welding to cool and simultaneously smooth the welding point. The cooling die preferably includes a cooling body composed of aluminum that is pressed directly onto the welding point. The cooling body is sized, for example, so that it fits between and through the spacers or the cutout in the spacer element.

When parts are joined that have continuous openings, e.g., a retainer of a distance sensor on the inside of a bumper or the plastic covering of a bumper, these openings must be centered relative to each other. To this end, the plastic welding device can also include a centering element that is essentially composed of a cylinder. The diameter of the cylinder is preferably different on two sides. In the case of two parts having openings of the same diameter, the first smaller diameter of the cylinder corresponds to the diameter of the opening of both parts. For centering, the centering element is inserted through the two openings. The same centering element can also be used if the diameters of the two openings in the plastic parts are different, whereby the respective diameters of the centering elements correspond to the respective diameters of the openings in the two parts. Hereby, the cylinder diameters correspond to the standard diameters of the sensor retainers and the sensor openings.

The plastic welding device is preferably a handheld plastic welding device in which the welding head is in the form of a soldering iron attachment resp. a soldering iron insert.

A method for attaching a sensor retainer having a thin-walled attachment section to the inside of the bumper covering can comprise the following steps: (a) Drilling a hole at the desired spot in the covering. This step is optional if a cutout is already provided. (b) Using the installation aid to position the sensor retainer. (c) Holding the sensor retainer in place by holding in place the thin-walled section by means of the installation aid. (d) Welding the two plastic parts together with the welding head. (e) Removing the welding head while continuing to hold the sensor retainer in place by the installation aid. (f) Cooling and smoothing the welding spot by means of the cooling die (optional). (g) Removing the installation aid.

A similar method involving welding and cooling can also be used to attach a first plastic part to any other second part (not necessarily composed of plastic), wherein the first plastic part with a hollow-cylindrical shape is inserted through an opening in the second part. Hereby, the joint is secured in the form of a rivet joint. In order to produce the rivet joint, a cylindrical welding head is used that has an axially raised, circumferential rim at the bottom, and a conical tip in the center, thereby creating a valley surrounding the axis between tip and rim. The welding head can be in the form of a soldering iron attachment or soldering iron insert. This welding head can be considered to be an independent invention.

In order to create the joint, the welding head with conical tip is pressed into the hollow-cylindrical section of the first plastic part, thereby causing the hollow-cylindrical section to deform and to expand over the rim of the opening in the second part. In order to cool the welded plastic rivets, a cooling die with a circumferentially larger cooling cylinder is used that has a planar bottom side. This method of plastic riveting can also be easily used in an automotive workshop, and in fact without the need for expensive equipment.

Another welding head that is capable of welding two plastic parts together edge-to-edge, e.g., along a crack, includes a cylindrical base body having a bottom side that is tilted relative to the soldering iron retainer. The base body having the tilted bottom side has a horseshoe shape. A drilled hole to introduce the plastic required for welding runs along the side of the cylinder up to the tilted bottom side. The opening on the bottom side is disposed concentrically or eccentrically. The base body has a V-shaped tip on the bottom side in front of the hole in the direction of welding. During the welding process the V-shaped tip melts a V groove between the two plastic parts that are subsequently filled with the supplied plastic. The enlarged melted area enables an especially clean and strong joint to be created between the two plastic parts. The V-shaped tip furthermore easily allows the welding speed to be controlled due to the resistance relative to the still-unmelted plastic.

The V-shaped tip can furthermore have a sword-shaped extension for welding thicker plastic parts or for welding on one side.

In order to weld plastic sheets together in a corner, the bottom side of the base body can be designed so as to be bilaterally parallel and flush with the sides of the V-shaped tip, thereby allowing the tip and the lateral surfaces of the bottom side to fit in a form-fitting manner into a right-angled corner. The bottom side is flattened in the area of the opening of the drilled hole, thereby creating a cutout during application in a corner, which cutout forms an oblique plastic filling when welding is effected in the corner.

The based body can have a rectangular shape instead of the cylinder, and the through-hole for introducing the plastic can be in the form of a slot. A V-shaped tip can also be provided on the bottom side of the rectangular base body. In addition, the bottom side in the welding direction can include a cutout after the slot running up to the rim for the purpose of applying a plastic coating to the surface of the two parts to be welded.

To provide a guide to move precisely along the crack, the welding head can include a groove running axially in front in the welding direction. The welding head can be in the form of a soldering iron attachment or soldering iron insert. This welding head having a V-shaped tip can be considered to be an independent invention.

### BRIEF DESCRIPTION OF SEVERAL VIEWS OF THE DRAWINGS

The following discussion describes the invention in more detail based on exemplary embodiments that relate to the drawing.

FIG. 1 is a perspective view of a welding head;

FIG. 2 is a perspective view of an embodiment of a handheld installation aid;

FIG. 3 is a front view of an installation aid with inserted welding head;

FIG. 4 is a perspective view of a hand soldering iron with inserted welding head;

FIG. 5 is a perspective view of a cooling die with cooling body;

FIG. 6 is perspective view of a centering element;

FIG. 7 is a perspective view of an installation aid of the embodiment in FIG. 2 with inserted welding head, and a first and second plastic part;

FIG. 8 is a front view of the handheld plastic welding device in FIG. 7;

FIG. 9 is a perspective view of another embodiment of a handheld installation aid with inserted welding head;

FIG. 10 is a perspective view of a welding head for plastic riveting;

FIG. 11a is a perspective view of one variant of a welding head to join planar plastic parts;

FIG. 11b is a perspective view of one variant of a welding head to join planar plastic parts;

FIG. 11c is a perspective view of one variant of a welding head to join planar plastic parts;

FIG. 12a is perspective view of a rectangular welding head; and

FIG. 12b is a perspective view of the rectangular welding head shown in FIG. 12a.

### DETAILED DESCRIPTION OF THE INVENTION

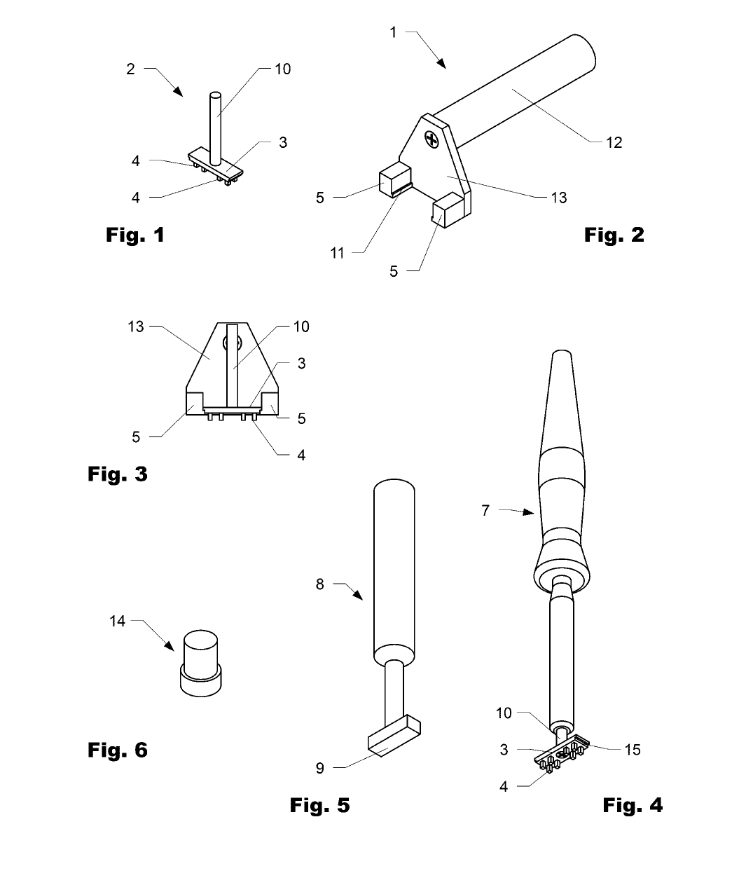

FIGS. 1 and 2 depicts a welding head 2 (FIG. 1) and an installation aid 1 (FIG. 2) of a handheld plastic welding device for the planar joining of a first, thin-walled plastic part 6 to a second plastic part.

FIG. 1 is a perspective view of welding head 2, comprising a plate-shaped base body 3 that includes a plurality (eight in FIG. 1) of welding tips 4 that are arranged in two longitudinal rows. Other arrangements and a different number of welding tips are also possible. A cylindrical rod 10 to be received in a hand soldering iron 7 is provided on the side of plate-shaped rectangular base body 3 opposite of the welding tips 4. The same welding head 2, inserted in hand soldering iron 7, is also depicted in FIG. 4 in a view of the bottom side of base body 3.

FIG. 2 is a perspective view of an embodiment of a handheld installation aid 1. Installation aid 1 has a handle 12 comprising a central attachment body in the form of an attachment plate 13. Two spacers 5 disposed a certain distance apart are removably attached, e.g., by means of a screw connection, to the attachment plate 13 so as to be flush with the bottom edge. Spacers 5 are in the form of protruding rectangular bodies and include a flange 11 on each side facing the other spacer. The thickness of the flange together with the length of welding tips 4 determine the maximum penetration depth of welding tips 4 into the plastic parts to be joined.

In order to change the penetration depth dependent on the thickness of thin-walled first plastic part 14, using identical welding head 2, it is possible to simply replace removably attached spacers 5 with spacers 5 having flange 11 of different thickness.

Base body 3 of welding head 2 in the depicted example also has a flange 15 on the rim that is complementary to flange 11 of spacer 5 so as to enhance the stability of welding head 2 relative to installation aid 1.

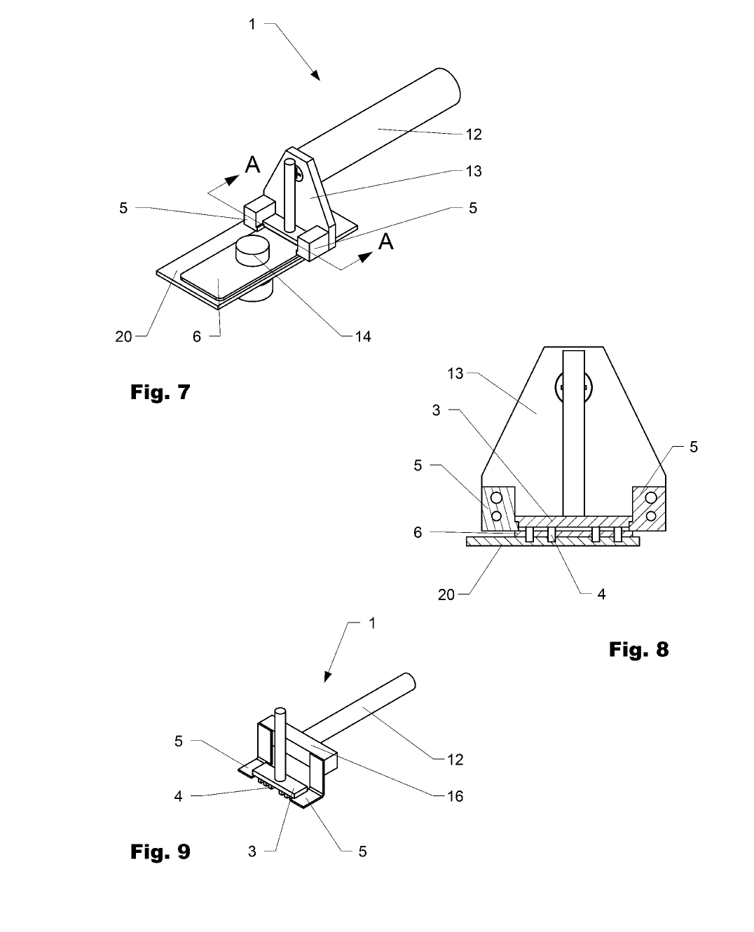

FIG. 3 is a front view of installation aid 1 with inserted welding head 2 of FIGS. 1 and 2. This reveals how welding tips 4 protrude below installation aid 1, and specifically in the region in which they are pressed into the two plastic parts during welding. This is also illustrated in FIG. 7 (perspective view) and FIG. 8 (front view), whereby these figures show the thin-walled first plastic part 6 and second plastic part 20. During welding, welding tips 4 are pressed through thin-walled first plastic part 6 into second plastic part 20 such that, after hardening, the molten plastic of the two plastic parts forms a strong welded joint. FIGS. 7 and 8 furthermore reveal that first plastic part 6 can be held by both spacers 5 resting on plastic part 6. Spacers 5 perform the function of holding the plastic parts and simultaneously ensuring an optimal penetration depth for welding tips 4.

FIG. 5 is a perspective view of a cooling die 8 with cooling body 9. In terms of its longitudinal extension, this is selected so as to be slightly smaller than the base body, thereby enabling it to be pressed between spacers 5 to effect cooling and effect pressing the material together onto the molten plastic. Cooling body 9 has a planar bottom side.

FIG. 6 is a perspective view of a centering element 14 used to align the two plastic parts with each other when joining plastic parts having through openings, e.g., a retainer of a distance sensor on the inside of a bumper or of the plastic covering of a bumper. FIG. 7 depicts a centering element 14 that is inserted into an opening of first plastic part 6. Centering element 14 includes a cylinder, the two sides of which have different diameters.

FIG. 9 is a perspective view of another embodiment of handheld installation aid 1 with inserted welding head 2. Unlike the installation aid in FIG. 2, installation aid 1 in FIG. 9 has a brace 16 attached to handle 12 as the central attachment body. Two angle brackets acting as spacers 5 are removably attached to the brace, e.g., by means of a screw connection. The maximum penetration depth of welding tips 4 into the plastic is determined by the thickness of the angle brackets.

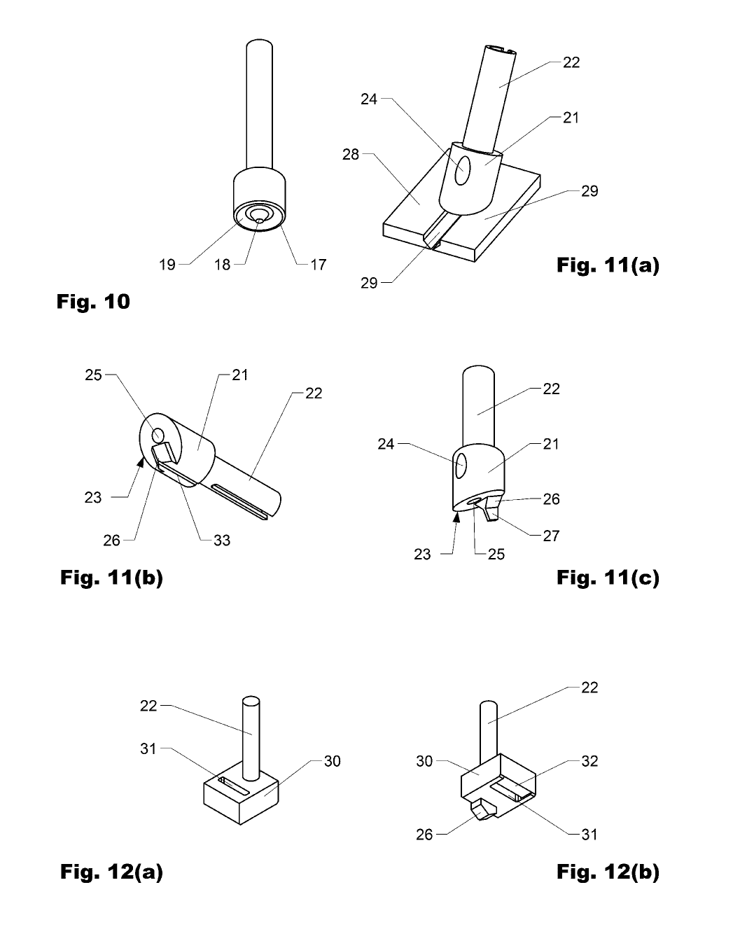

FIG. 10 is a perspective view of a welding head for producing plastic rivet joints. The welding head has a cylindrical base body and is preferably in the form of a soldering iron attachment or soldering iron insert. The cylindrical base body has on the bottom side an axially raised circumferential rim 17 and a conical tip 18 at the center, thereby creating a circumferential valley 19 between tip 18 and rim 17.

FIG. 11 is a perspective view of two variants of a welding head for welding two plastic parts. FIG. 11(a) provides a perspective view from above of the welding head and the plastic parts 28, 29 to be welded (the perspective is identical for both variants.) FIGS. 11(b) and 11(c) provide a perspective view from below of the bottom side of the welding head.

The welding head has a cylindrical base body 21 including a bottom side 23 that is tilted relative to the soldering iron retainer 22. Based body 21 with a tilted bottom side 23 has a horseshoe-like shape (FIG. 11(a)). A V groove is shown in the joining region of both plastic parts 28, 29, which groove is created by V-shaped tip 26 of the welding head and is filled with supplied plastic (not shown). The supplied plastic and the rim section of both plastic parts 28, 29 create a strong durable welded joint.

A drilled hole 24 for introducing the plastic required for welding runs along the side of cylindrical base body 21 up to the tilted bottom side 23. Opening 25 of the drilled hole 24 is disposed eccentrically. The base body has a V-shaped tip 26 in the welding direction in front of opening 25 on the bottom side 23, as shown in FIGS. 11(b) and 11(c). During the welding process, V-shaped tip 26 melts a V groove between the two plastic parts, which groove is subsequently filled with the supplied plastic. This creates an especially clean and strong joint of the two plastic parts. V-shaped tip 26 can also include a sword-shaped extension 27, as shown in FIG. 11(c), for welding thicker plastic parts together.

Instead of the cylinder, the base body can be of rectangular shape, and the through hole for introducing the plastic can be in the form of a slot. The welding head can have an axially running groove at the front as a guide for moving precisely along a crack.

FIG. 12 is a perspective view of a welding head that, unlike the welding heads in FIG. 11, has a rectangular base body. FIG. 12(a) is a perspective view of the welding head from above, while FIG. 12(b) is a perspective view from below. A slot 31 can be provided instead of the drilled hole to deliver the plastic. V-shaped tip 26 can similarly be provided on the bottom side of the rectangular base body 30. In addition, the bottom side in the welding direction can have a cutout 32 after slot 31 running up to the rim for applying a plastic coating to the surface of both parts 28, 29 to be welded.

The welding heads in FIGS. 11 and 12 can have an axially running groove in welding direction at the front as a guide 33 for moving precisely along a crack, as shown in FIG. 11(b).

1-11. (canceled)

12. A plastic welding device for the planar joining of a first thin-walled plastic part to a second plastic part, the plastic welding device comprising:
a handheld installation aid and a welding head that can be received in a retainer of a hand soldering iron, wherein the welding head includes a base body and at least one welding tip disposed on the base body, wherein the handheld installation aid includes at least one spacer placed on a bottom side onto the thin-walled plastic part, and wherein a top side of the at least one spacer supports the base body, the at least one spacer sized so a penetration depth of the at least one welding tip into the plastic parts to be joined is limited to a predetermined maximum value when the base body is supported on the at least one spacer.

13. The plastic welding device according to claim 12, wherein the installation aid includes two spacers that are disposed a certain distance apart such that the at least one welding tip of the welding head can be placed between the two spacers when the base body is supported on the spacers.

14. The plastic welding device according to claim 12, wherein the installation aid includes a central attachment body with a handle on which the at least one spacer is removably attached.

15. The plastic welding device according to claim 12, wherein the welding head includes a plurality of welding tips.

16. The plastic welding device according to claim 15, wherein the base body forms a plate having a bottom side on which the welding tips are disposed.

17. The plastic welding device according to claim 12, wherein the plastic welding device comprises a handheld plastic welding device.

18. The plastic welding device according to claim 12, wherein the installation aid includes a guide for the welding head.

19. The plastic welding device according to claim 12, further comprising a cooling die with a cooling body.

20. The plastic welding device according to claim 12, further comprising a centering element.

21. The plastic welding device according to claim 12, wherein the welding head comprises a soldering iron attachment or a soldering iron insert.

22. The plastic welding device according to claim 12, wherein the predetermined maximum value of the penetration depth is in the range from 3 mm to 6 mm.
